(19) United States
(12) Patent Application Publication
(10) Pub. No.: US 2015/0146158 A1
(43) Pub. Date: May 28, 2015

(54) STRUCTURE OF EYEGLASSES

(71) Applicant: TRIMAX SAFETY CORP., Tainan City (TW)

(72) Inventors: SHIH-I LEE, Tainan City (TW); CHING-HSIU CHAN, Tainan City (TW)

(73) Assignee: TRIMAX SAFETY CORP., Tainan City (TW)

(21) Appl. No.: 14/092,983

(22) Filed: Nov. 28, 2013

(51) Int. Cl. G02C 5/00; G02C 1/06

(52) U.S. Cl. CPC G02C 5/001; G02C 1/06; G02C 2200/06; G02C 2200/08
USPC 351/86

(57) ABSTRACT

Disclosure relates to a structure of eyeglasses, including a body of eyeglasses integrally formed to include a mid-rim and two frames, the mid-rim being disposed between the two frames and surrounded thereby to form a nose bridge, a holding recess being concavely disposed at the mid-rim, the holding recess having a buckling portion, each of the frames having a lens bearing portion for bearing lens, an opening of the lens bearing portion being disposed at the holding recess, and another side of each of the frames opposite to a side where the mid-rim is connected being movably arranged with a temple; and a buckling member being arranged with a shape corresponding to that of the holding recess, and being detachably disposed to the buckling portion of the mid-rim. The present invention is therefore easy to disassemble or replace lens.

### BACKGROUND OF THE INVENTION

1. Field of the Invention

The present invention generally relates to a structure of eyeglasses, in particular with respect to a structure of eyeglasses that is easy to disassemble or replace the lens.

2. Description of the Related Art

Recently, as the development of video device, people cannot get rid of using the devices from the public to private, but if they spend too much time on the devices or in the wrong pose while utilizing, slight fatigue of eyesight may occur, or more seriously, may cause unexpected damage to the vision. As a result, people often wear eyeglasses to adjust their sight or to protect the eyes from being damaged by ultraviolet rays or Blu-ray.

Regarding a commonly used eyeglasses, the lens thereof are mostly immovably disposed upon the frame, such as arranging a lens bearing portion for surrounding and buckling the lens. Even though the above eyeglasses can accomplish the effect of buckling the lens on the frame, an obstacle to disassemble or replace lens is therefore caused, and the user is incapable of replacing the lens at will and need to spend much time on disassembling or arranging the lens; and moreover, damage to the frame may happen. In view of the aforementioned problem, the current structure of eyeglasses still leaves much space to improve.

As a result, the creator of the present invention designs a structure of eyeglasses which aims for overcoming the existing drawbacks and wish to improve the industrial applicability.

### SUMMARY OF THE INVENTION

In view of the above-mentioned problem, a structure of eyeglasses is provided to overcome the obstacle to disassemble or replace the lens.

According to the goal of the present invention, a structure of eyeglasses is provided, comprising a body of eyeglasses integrally formed to include a mid-rim and two frames, the mid-rim being disposed between the two frames and surrounded thereby to form a nose bridge, a holding recess being concavely disposed at the mid-rim, the holding recess having a buckling portion, each of the frames having a lens bearing portion for bearing lens, an opening of the lens bearing portion being disposed at the holding recess, and another side of each of the frames opposite to a side where the mid-rim is connected being movably arranged with a temple; and a buckling member being arranged with a shape corresponding to that of the holding recess, and being detachably disposed to the buckling portion of the mid-rim.

Preferably, the holding recess is disposed with a gap for forming the buckling portion together with a bottom side of the holding recess.

Preferably, the buckling member is disposed with a retaining clamp facing to a side of the holding recess corresponding to the buckling portion, and the retaining clamp fastens a side of the gap and the bottom side of the holding recess through the gap.

Preferably, another side of each of the frames is disposed with a first pivot, an end of each of the temples is disposed with a second pivot, and the temples are pivotally disposed to the frames by the first pivot and the second pivot.

Preferably, further comprises two connectors, respectively disposed at another end of each of the temples, for connecting to an eyeglasses attachment therethrough.

Preferably, the structure of eyeglasses further comprises two nose pads, respectively disposed at a rear side of the frames adjacent to the nose bridge.

Preferably, each of the frames adjacent to the nose bridge is disposed with a plurality of first connection portions, the nose pads are disposed with a plurality of second connection portions corresponding to the plurality of first connection portions, and the nose pads are disposed at the rear side of the frames by the first connection portions and the second connection portions.

To sum up, the structure of eyeglasses of the present invention may have one or more following advantages:

(1) The structure of eyeglasses of the present invention may expose the opening of the lens bearing portion by disassembling the buckling member for easy to disassemble and replace lens.

(2) The structure of eyeglasses of the present invention may use the arrangement of buckling portion of the holding recess and the retaining clamp of the buckling member to contribute to the disassembly of buckling member, for easy to disassemble and replace lens.

### BRIEF DESCRIPTION OF THE DRAWINGS

FIG. 1 is an explosion diagram of structure of eyeglasses in accordance with the present invention.

FIG. 2 is an assembly diagram of rear view of structure of eyeglasses in accordance with the present invention.

FIG. 3 is an assembly diagram of front view of structure of eyeglasses in accordance with the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

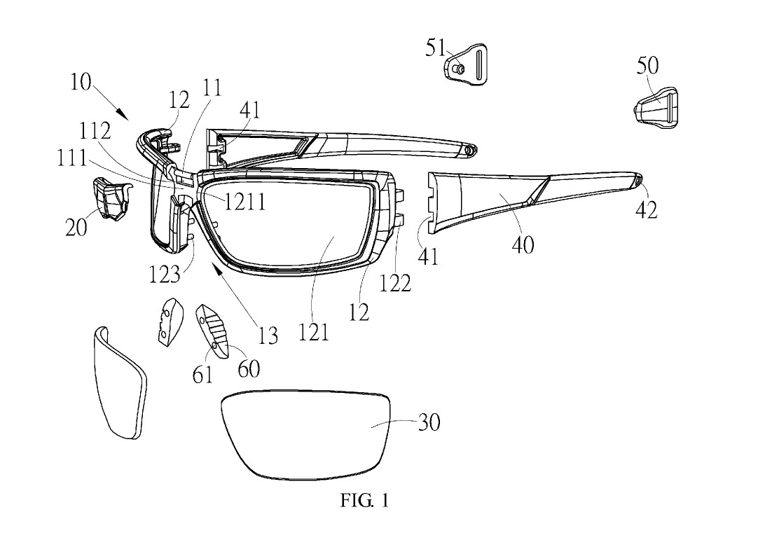

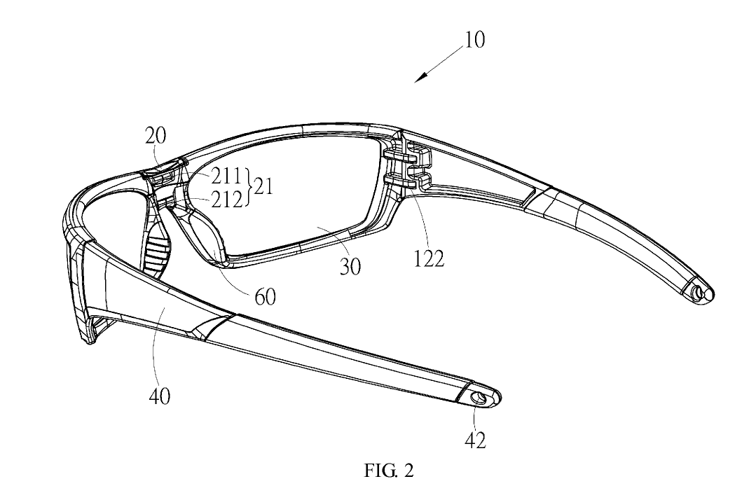

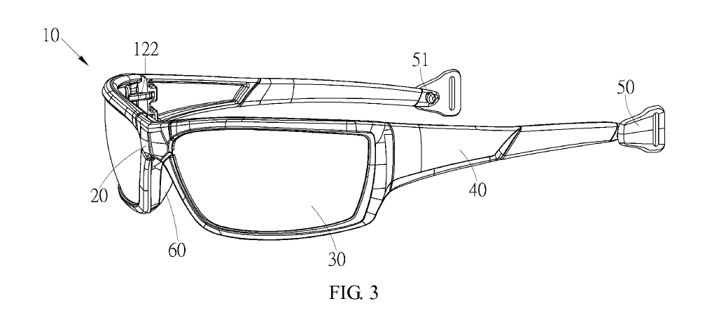

With reference to FIGS. 1 to 3, that respectively indicates an explosion diagram of structure of eyeglasses, an assembly diagram of rear view of structure of eyeglasses and an assembly diagram of front view of structure of eyeglasses in accordance with the present invention. As shown in the FIGS., the structure of eyeglasses 1 of the present invention comprises a body of eyeglasses 10 and a buckling member 20. Wherein the body of eyeglasses 10 comprises a mid-rim 11 and two frames 12. The mid-rim 11 and the frames 12 are integrally formed, the mid-rim 11 is disposed between the two frames 12 to integrate with the two frames 12, and the mid-rim 11 and the side wall of the frames 12 adjacent to the mid-rim 12 formed a nose bridge 13 for holding user's nose. The front side of mid-rim 11 inwardly dents to form a holding recess 111 and a buckling portion is disposed within the holding recess 111, wherein the buckling portion is formed by a gap 112 and a bottom side of the holding recess 111.

Wherein, the shape of the buckling member 20 is arranged corresponding to the shape of the holding recess 111, held in the holding recess 111 and is detachable to buckle the buckling portion. Further, the buckling member 20 has a retaining clamp 21 disposed facing to a side of the holding recess 111 corresponding to a gap 112 of the buckling portion that adjacent to a side of the bottom side of the holding recess 111 and a bottom side of the holding recess 111 (as shown in FIG. 2). When the buckling member 20 held in the holding recess 111, one of the side clamps 211 of the retaining clamp 21 may through the gap 112 to buckle the gap 112 that adjacent to a side of the bottom side of the holding recess 111, and the other side clamp 212 of the retaining clamp 21 may buckle a side of the bottom side of the holding recess 111, so that the buckling member 20 may easy to disassemble. It is noteworthy to note that due to the shape of the buckling member 20 is arranged corresponding to the shape of the holding recess 111, consequently, when the buckling member 20 held in the holding recess 111, the entity may look like an integration and does not have any inappropriate effects (as shown in FIG. 1). Certainly, the color of buckling member 20 and the body of eyeglasses 10 may be set as the same, so that the buckling member 20 may prettify the structure of eyeglasses 1.

In addition, each frame 12 has a lens bearing portion 121 for bearing lens 30. Wherein an opening 1211 of the lens bearing portion 121 is disposed at the holding recess 111. Wherein, the opening 1211 may be apparently exposed till the buckling member 20 is disassembled from the holding recess 111, and when the buckling member 20 buckles the holding recess 111, the opening 1211 may be covered by the corresponding shape of the buckling member 20. By means of arranging the opening 1211, when the user hopes to disassemble the lens 30, by forcing through the opening 1211, the lens 30 can be easily disassembled and therefore is easy to replace another lens.

On the other hand, another side of each frame 12 opposite to a side connected to the mid-rim 11 may arrange mobile temples 40, respectively. Further, another side of frame 12 may arrange a first pivot 122, and an end of temples 40 corresponding to the first pivot 122 arranges a second pivot 41, the temples 40 may connect to another side of frame 12 by means of the first pivot 122 and the second pivot 41. For example, the first pivot 122 may be one or more convex that protrudes on the frame 12, and may arrange the through hole in the direction vertical to the convex, and the second pivot 41 may corresponding to the convex to arrange one or more capacity slots, and may also arrange the through hole in the direction perpendicular to the convex. When the first pivot 122 connects to the second pivot 41, the temples 40 may be rotationally fixed on the frame 12 by means of penetrating a joint through the through hole.

Regarding the temples 40, it is noteworthy to note that another end of each temple 40 provides with a detachable connector 50. By using the connector 50, the user can connect an eyeglasses attachment (not shown in FIGS.) to the structure of eyeglasses 1, and the eyeglasses attachment may be a retaining strap. Wherein, the connector 50 is detachable, for example, arranging a through hole 42 on another end of the temples 40, and the connector 50 correspondingly disposes a buckling pillar 51 for penetrating through the through hole 42 to buckle.

In addition, the structure of eyeglasses further comprises two nose pads 60, which are respectively arranged on the rear side of frame 12 that adjacent to the nose bridge 13. More specifically, the rear side of each frame 12 that adjacent to the nose bridge 13 may arrange a plurality of pillar-like first connection portions 123, and each nose pad 60 corresponding to the first connection portions 123 may arrange a plurality of blind hole-like second connection portions 61. The nose pad 60 may be arranged on the rear side of the frame 12 by embedding the first connection portions 123 in the second connection portions 61. By the way, through tightly fit or bonding, the first connection portions 123 and the second connection portions 61 can be firmly fixed.

The structure of eyeglasses of the present invention aims at arranging a detachable buckling member on the body of eyeglasses and exposing the opening while disassembling the buckling member, so that it is easy to disassemble or replace lens.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A structure of eyeglasses, comprising:
a body of eyeglasses integrally formed to include a mid-rim and two frames, the mid-rim being disposed between the two frames and surrounded thereby to form a nose bridge, a holding recess being concavely disposed at the mid-rim, the holding recess having a buckling portion, each of the frames having a lens bearing portion for bearing lens, an opening of the lens bearing portion being disposed at the holding recess, and another side of each of the frames opposite to a side where the mid-rim is connected being movably arranged with a temple; and
a buckling member being arranged with a shape corresponding to that of the holding recess, and being detachably disposed to the buckling portion of the mid-rim.

2. The structure of eyeglasses as claimed in claim 1, wherein the holding recess is disposed with a gap for forming the buckling portion together with a bottom side of the holding recess.

3. The structure of eyeglasses as claimed in claim 2, wherein the buckling member is disposed with a retaining clamp facing to a side of the holding recess corresponding to the buckling portion, and the retaining clamp fastens a side of the gap and the bottom side of the holding recess through the gap.

4. The structure of eyeglasses as claimed in claim 1, wherein another side of each of the frames is disposed with a first pivot, an end of each of the temples is disposed with a second pivot, the temples are pivotally disposed to the frames by the first pivot and the second pivot.

5. The structure of eyeglasses as claimed in claim 4, further comprising two connectors, respectively disposed at another end of each of the temples, for connecting to an eyeglasses attachment therethrough.

6. The structure of eyeglasses as claimed in claim 1, further comprising two nose pads, respectively disposed at a rear side of the frames adjacent to the nose bridge.

7. The structure of eyeglasses as claimed in claim 6, wherein each of the frames adjacent to the nose bridge is disposed with a plurality of first connection portions, the nose pads are disposed with a plurality of second connection portions corresponding to the plurality of first connection portions, and the nose pads are disposed at the rear side of the frames by the first connection portions and the second connection portions.
